(19) United States
(12) Patent Application Publication
(10) Pub. No.: US 2011/0067280 A1
(43) Pub. Date: Mar. 24, 2011

(54) BANNER HEM SEALING APPARATUS FOR USE WITH IMPULSE SEALER AND METHOD OF USING THE SAME

(76) Inventor: Michael L. Pender, Ann Arbor, MI (US)

(21) Appl. No.: 12/648,712

(22) Filed: Dec. 29, 2009

Related U.S. Application Data
(60) Provisional application No. 61/244,864, filed on Sep. 22, 2009.

(51) Int. Cl. G09F 17/00; B29C 65/38; B29C 65/02

(52) U.S. Cl. 40/604; 156/499; 156/227

(57) ABSTRACT

The present disclosure provides a banner hem sealing apparatus for use with impulse sealer and method of using the same. The apparatus is designed to reduce the misalignment problem caused when an impulse sealer is used to hem a banner. The apparatus is comprised of: a first member which comprises a tray and the means to mount to a second member; the second member which comprises an opening, a fence, a backplate, and the means to mount to the first member.

### CROSS-REFERENCE TO RELATED APPLICATIONS

This application claims the benefit of U.S. Provisional Application 61/244,864 filed Sep. 22, 2009. The content of this prior application is incorporated by reference in its entirety.

### BACKGROUND OF THE INVENTION

One method of making banners is to bond together two polymeric sheets of material using heat and pressure. The edges of the banner must then be hemmed to avoid fraying of the edges and provide support for the installation of grommets or rings. The grommets or rings are used to properly mount the banner in a location where it is visible and useful.

### BRIEF SUMMARY OF THE INVENTION

The present disclosure provides a banner hem sealing apparatus for use with impulse sealer and method of using the same. The apparatus is designed to reduce the misalignment problem caused when an impulse sealer is used to hem a banner. The apparatus is comprised of: a first member which comprises a tray and the means to mount to a second member; and the second member which comprises an opening, a fence, a backplate, and the means to mount to the first member.

The tray of the first member is designed to hold the banner during the hemming process. The tray may vary in length, width, and height to accommodate the expected banner requirements.

The means to mount the first member to the second member may be embodied in different ways. One embodiment is to use a wing nut and bolt on each side of the apparatus. The bolts are inserted into a holes existing on each side of the first and second members of the apparatus and secured with the wing nuts. Instead of a circular hole, an oblong oval may be used to allow different settings for mounting the first member. Alternately, a plurality of holes may exist to allow different settings for mounting the first member to the second member.

The opening of the second member is used to allow the impulse sealer to operate properly.

The fence is used to enable alignment of the banner during the hemming process. The fence is typically ½″ to 2″ high. The length of the fence matches or exceeds the length of the impulse sealer element.

The backplate is used to mount the apparatus to an impulse sealer.

### BRIEF DESCRIPTION OF THE DRAWINGS

FIG. 1 shows a banner hem sealing apparatus for use with an impulse sealer.

FIG. 2 shows an embodiment of an impulse sealer.

FIG. 3 shows a banner hem sealing apparatus combined with an impulse sealer.

### DETAILED DESCRIPTION OF THE INVENTION

One method of making banners is to bond together two polymeric sheets of material using heat and pressure. The edges of the banner must then be hemmed to avoid fraying of the edges and provide support for the installation of grommets or rings. The grommets or rings are used to properly mount the banner in a location where it is visible and useful.

Typically, the banner edges are hemmed in one of three ways. The first method is to sew the hem. This is labor intensive and requires a specialized sewing machine. The second method is to tape the hem. This is also labor intensive and can get messy if the tape is misapplied. The tape adhesive may also fail in both interior and exterior applications. The third method is to seal or weld the hem using a combination of heat and pressure. This may be accomplished with an impulse sealer. However, using an impulse sealer to hem a banner is labor intensive and prone to hem misalignment.

The present disclosure describes a banner hem sealing apparatus, hereafter referred to as the apparatus, designed to reduce the misalignment problem caused when an impulse sealer is used to hem a banner. One unexpected result is that the apparatus also reduces the labor cost of hemming a banner.

Another unexpected result is that the apparatus may be used to make pole pockets. A pole pocket is the opening that is required to mount a flag on a pole. Creating a pole pocket on a banner allows it to be used as a flag.

Another unexpected result is that the apparatus may be used to make a pocket sign. An embodiment of a pocket sign is a rectangular banner which is folded in half to make a creased top edge. The pocket sign is then hemmed on the two sides. A wire or some other mounting device is inserted in the bottom of the pocket sign. To use the pocket sign, the opposite end of the wire or mounting device is stuck into the ground.

The apparatus is comprised of: a first member which comprises a tray and the means to mount to a second member; and the second member which comprises an opening, a fence, a backplate, and the means to mount to the first member.

The tray of the first member is designed to hold the banner during the hemming process. The tray may vary in length, width, and height to accommodate the expected banner requirements.

The means to mount the first member to the second member may be embodied in different ways. One embodiment is to use a wing nut and bolt on each side of the apparatus. The bolts are inserted into a holes existing on each side of the first and second members of the apparatus and secured with the wing nuts. Instead of a circular hole, an oblong oval may be used to allow different settings for mounting the first member. Alternately, a plurality of holes may exist to allow different settings for mounting the first member to the second member.

The opening of the second member is used to allow the impulse sealer to operate properly.

The fence is used to enable alignment of the banner during the hemming process. The fence is typically ½″ to 2″ high. The length of the fence matches or exceeds the length of the impulse sealer element.

The backplate is used to mount the apparatus to an impulse sealer.

For the purposes of this disclosure, an impulse sealer comprises the means to apply heat and pressure to create a hem.

The method used to make a banner hem comprises: folding the banner along the side where the hem will be; placing the edge of the folded side adjacent to the fence; and activating the impulse sealer to apply pressure and heat to the folded side.

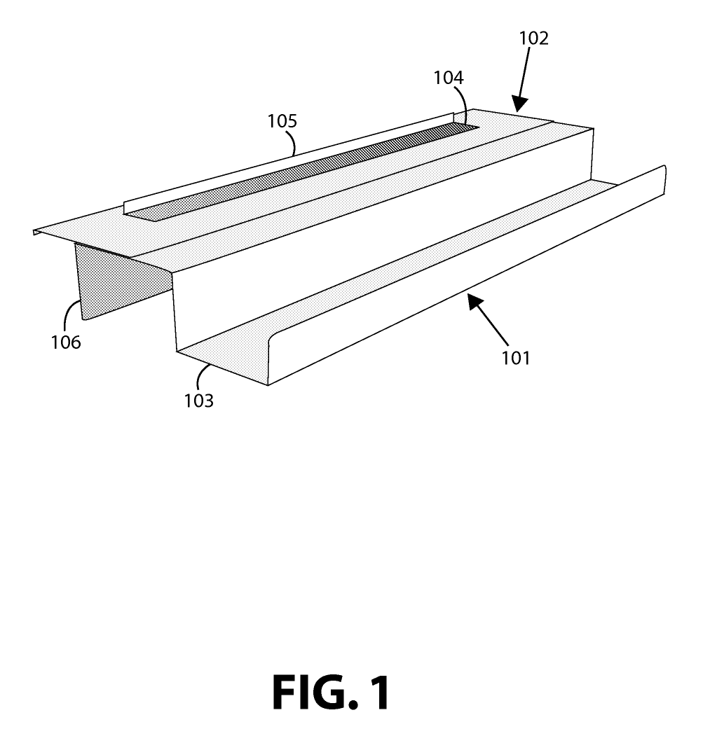

FIG. 1 shows an embodiment of a banner hem sealing apparatus for use with an impulse sealer. A first member 101 is mounted onto a second member 102. First member 101 includes a tray 103. Second member 102 includes an opening 104 for the heating and gripping elements of a sealer. A fence 105 runs parallel to one side of opening 104. A backplate 106 is used to mount the apparatus onto an impulse sealer.

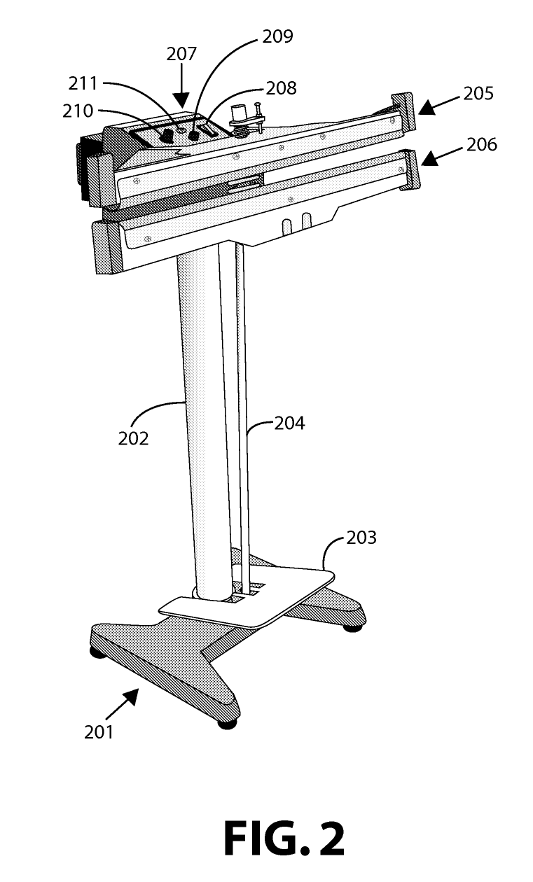

FIG. 2 shows an embodiment of an impulse sealer. The impulse sealer is mounted on a stand 201. Stand 201 is connected to a column 202 which connects to other elements of the impulse sealer. A foot pedal 203 is used to actuate the impulse sealer and is connected to a rod 204. Rod 204 controls the raising and lowering of a heat element 205. Heat element 205 compresses a fold in conjunction with a bottom-lip element 206. A control pad 207 handles critical functions of the impulse sealer. Included on control pad 207 is an off/on switch 208, a fuse 209, an energy output control or timer 210, and an activation indicator 211.

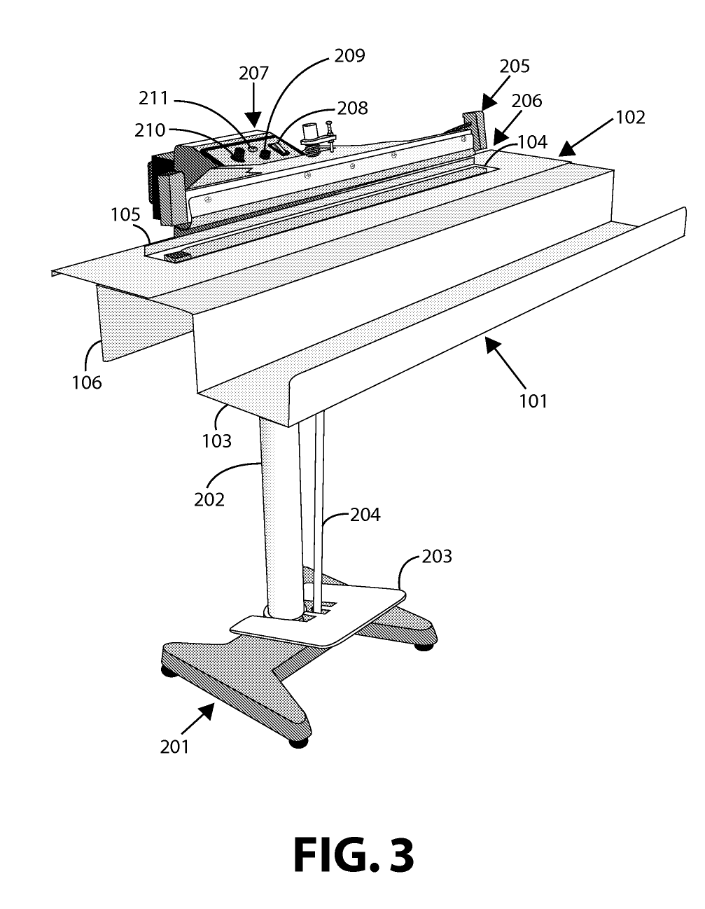

FIG. 3 shows a banner hem sealing apparatus combined with an impulse sealer. First member 101 is mounted onto second member 102. First member 101 includes tray 103. Second member 102 includes an opening 104 for the heating and gripping elements of a sealer. Fence 105 runs parallel to one side of opening 104. Backplate 106 is used to mount the apparatus onto an impulse sealer. The impulse sealer is mounted on stand 201. Stand 201 is connected to column 202 which connects to other elements of the impulse sealer. Foot pedal 203 is used to actuate the impulse sealer and is connected to rod 204. Rod 204 controls the raising and lowering of heat element 205. Heat element 205 compresses a fold in conjunction with bottom-lip element 206. Control pad 207 handles critical functions of the impulse sealer. Included on control pad 207 is off/on switch 208, fuse 209, energy output control or timer 210, and activation indicator 211.

While the disclosure describes embodiments and various alternatives thereto, it should be apparent that the invention is not limited to such embodiments. Rather, many variations would be apparent to persons of skill in the art without departing from the scope and spirit of the invention.

I claim:

1. A banner hem sealing apparatus for use with an impulse sealer, the apparatus comprising:
a first member which further comprises a tray and the means to mount to a second member; and
the second member which further comprises an opening, a fence, a backplate, and the means to mount to the first member.

2. The apparatus of claim 1, wherein the fence is approximately ½″ to 2″ high.

3. The apparatus of claim 1, wherein the means to mount to a second member and the means to mount to the first member comprise bolts and wing nuts fastened together.

4. The apparatus of claim 2, wherein the means to mount to the second member and the means to mount to the first member comprise bolts and wing nuts fastened together.

5. A method of using a banner hem sealing apparatus in conjunction with an impulse sealer, the method comprising:
creating a folded banner side where a hem will be;
placing the edge of the folded banner side adjacent to a fence; and
activating an impulse sealer to apply pressure and heat to the folded banner side.

6. A banner prepared in accordance with the method of claim 5.

7. A pole pocket prepared in accordance with the method of claim 5.

8. A pocket sign prepared in accordance with the method of claim 5.
